(19) United States
(12) Patent Application Publication
(10) Pub. No.: US 2007/0043932 A1
(43) Pub. Date: Feb. 22, 2007

(54) Wakeup mechanisms for schedulers

(75) Inventors: Rahul Kulkarni, Portland, OR (US); Avinash Sodani, Portland, OR (US)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/208,916

(22) Filed: Aug. 22, 2005

(51) Int. Cl. G06F 9/30

(52) U.S. Cl. 712/214

(57) ABSTRACT

Methods and apparatus to provide wakeup mechanisms for schedulers are described. In one embodiment, a scheduler broadcasts a uop scheduler identifier of a scheduled uop (or micro-operation) to one or more uops awaiting scheduling. The scheduler may further update one or more corresponding entries in a uop dependency matrix or a uop source identifiers and data buffer.

### BACKGROUND

The present disclosure generally relates to the field of computing. More particularly, an embodiment of the invention relates to wakeup mechanisms for schedulers.

To improve performance, some processors execute instructions in parallel. To execute different portions of a single program in parallel, a scheduler may schedule some instructions for execution out of their original order.

Generally, “uops” (micro-operations) wait at the scheduler until they are ready for execution. If the source data of a uop is not ready, the uop may store a “tag” value for its source that identifies the parent uop of that source. Once the parent uop executes and provides its execution result, the tagged uop may utilize the result for its tagged source and dispatch for execution.

The process of waking up and scheduling a uop that is waiting for valid source data can be time critical, especially for uops that are to be awaken in a single clook cycle. As the depth of the scheduler increases (e.g., for performance reasons), the number of uops waiting in a scheduler may increase and, as a result, it may become more difficult to wake up and schedule a uop in a single cycle, or a limit may have to be put on the number of uops that may wait for valid source data at the scheduler.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of portions of a processor core, according to an embodiment of the invention.

FIG. 2 illustrates a block diagram of an embodiment of a schedule unit.

FIG. 3 illustrates a flow diagram of an embodiment of a method to allocate a new uop in a schedule unit.

FIG. 4 illustrates a flow diagram of an embodiment of a method to schedule uops with source dependencies for execution.

FIG. 5 illustrates a flow diagram of an embodiment of a method to update uop source data.

FIGS. 6 and 7 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

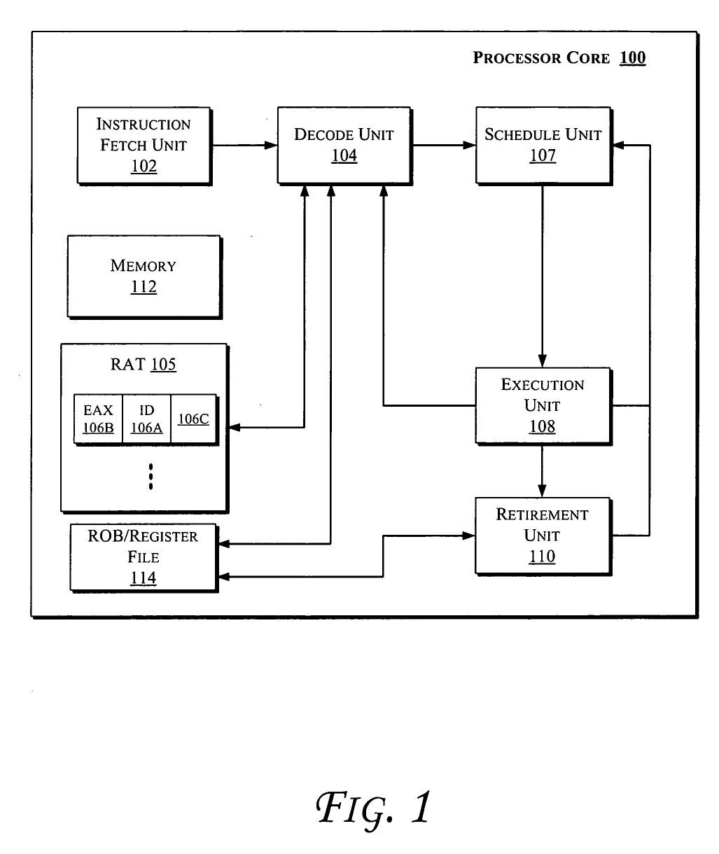

Techniques discussed herein with respect to various embodiments may efficiently utilize a matrix wakeup mechanism for reservation based (RS) schedulers in a processing element, such as the processor core shown in FIG. 1. More particularly, FIG. 1 illustrates a block diagram of portions of a processor core 100, according to an embodiment of the invention. In one embodiment, the arrows shown in FIG. 1 indicate the direction of data flow. One or more processor cores (such as the processor core 100) may be implemented on a single integrated circuit chip. Moreover, the chip may include one or more shared or private caches, interconnects, memory controllers, or the like.

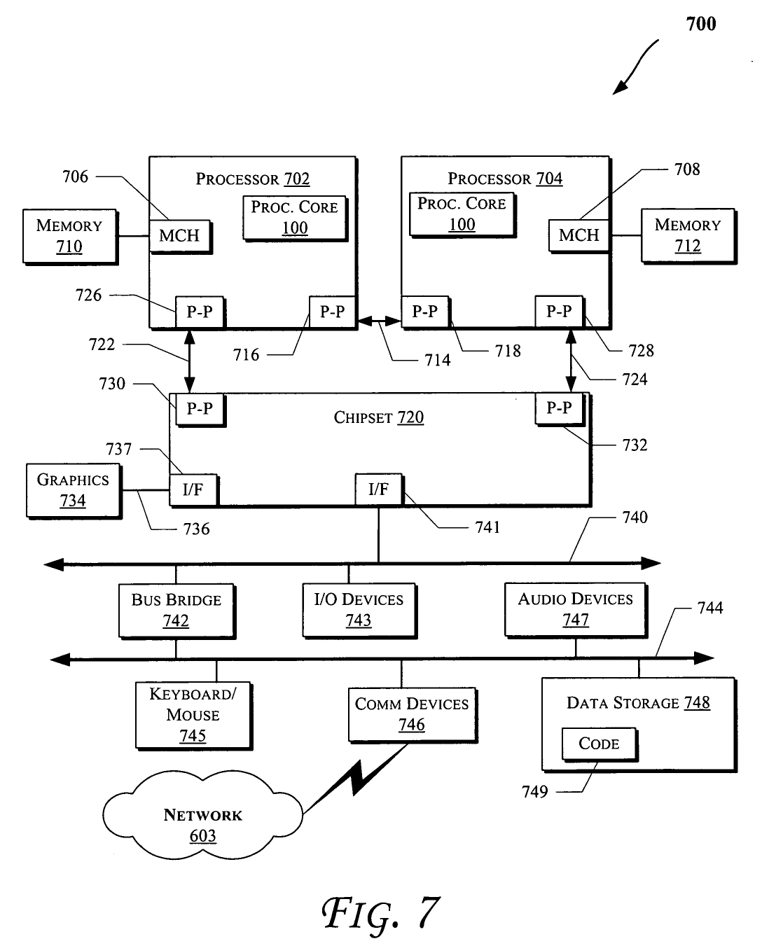

As illustrated in FIG. 1, the processor core 100 includes an instruction fetch unit 102 to fetch instructions for execution by the core 100. The instructions may be fetched from any suitable storage devices such as the memory devices discussed with reference to FIGS. 6 and 7. The instruction fetch unit 102 may be coupled to a decode unit 104 which decodes the fetched instruction and may determine instruction dependencies. For instance, the decode unit 104 may decode the fetched instruction into a plurality of uops. The decode unit 104 may be coupled to a RAT (register alias table) 105 to maintain a mapping of logical (or architectural) registers (such as those identified by operands of software instructions) to corresponding physical registers. Hence, each entry in the RAT 105 may include a physical register identifier (ID) 106A assigned to each register 106B, along with a single-cycle dependency ID 106C (e.g., a status bit) that indicates whether a given entry in the RAT 105 has a dependency on a single-cycle uop. Generally, a uop (e.g., uopA) may be a single-cycle uop if it is required to wake up a dependent uop (e.g., uopB) such that the dependent uop (uopB) can become eligible for scheduling by a schedule unit 107 in the next cycle of the processor core 100. Generally, waking up a uop refers to resuming execution of a uop that has been waiting for its source data to become available, e.g., waiting at the schedule unit 107.

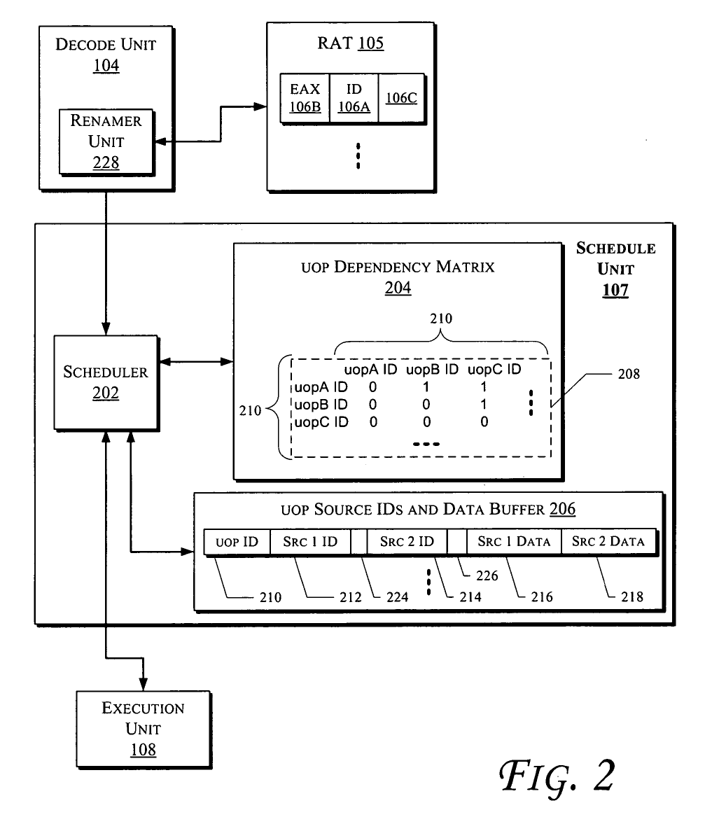

More particularly, as will be further discussed with reference to FIGS. 2-5, the schedule unit 107 may hold decoded instructions (e.g., from the decode unit 104) until they are ready for dispatch, e.g., until all source values of a decoded instruction become available. For example, with respect to an “add” instruction, the “add” instruction may be decoded by the decode unit 104 and the schedule unit 107 may hold the decoded “add” instruction until the two values that are to be added become available. Hence, the schedule unit 107 may schedule and/or issue (or dispatch) decoded instructions to various components of the processor core 100 for execution, such as an execution unit 108. The execution unit 108 may execute the dispatched instructions after they are decoded (e.g., by the decode unit 104) and dispatched (e.g., by the schedule unit 107). In one embodiment, the execution unit 108 may include one or more suitable execution units (not shown), such as a memory execution unit, an integer execution unit, a floating-point execution unit, or the like. The execution unit 108 may be coupled to a retirement unit 110 to retire executed instructions after they have finished execution.

As illustrated in FIG. 1, the retirement unit 110 may be coupled back to the schedule unit 107 to provide data regarding retired instructions. Moreover, the execution unit 108 may be coupled back to the schedule unit 107 to communicate data regarding executed instructions, e.g., to facilitate dispatch of dependent instructions. Hence, the schedule unit 107 may be an out-of-order schedule unit in one embodiment.

In one embodiment, such as shown in FIG. 1, the processor core 100 may also include a memory 112 to store instructions and/or data that are utilized by one or more components of the processor core 100. In an embodiment, the memory 112 may include one or more caches (that may be shared), such a level 1 (L1) cache, a level 2 (L2) cache, or the like. Various components of the processor core 100 may be coupled to the memory 112 directly, through a bus, and/or memory controller or hub. The processor core 100 may further include a reorder buffer (ROB)/register file 114 to store information about in flight instructions (or uops) for access by various components of the processor core 100. In one embodiment, various components of the processor core 100 may be, but are not required to be, provided in the memory 112, such as the RAT 105 and/or the ROB/register file 114.

FIG. 2 illustrates a block diagram of an embodiment of a schedule unit (107). In one embodiment, the arrows shown in FIG. 2 indicate the direction of data flow. The decode unit 107 may include a scheduler 202 that receives decoded instructions from the decode unit 104 and schedules them for execution by the execution unit 108.

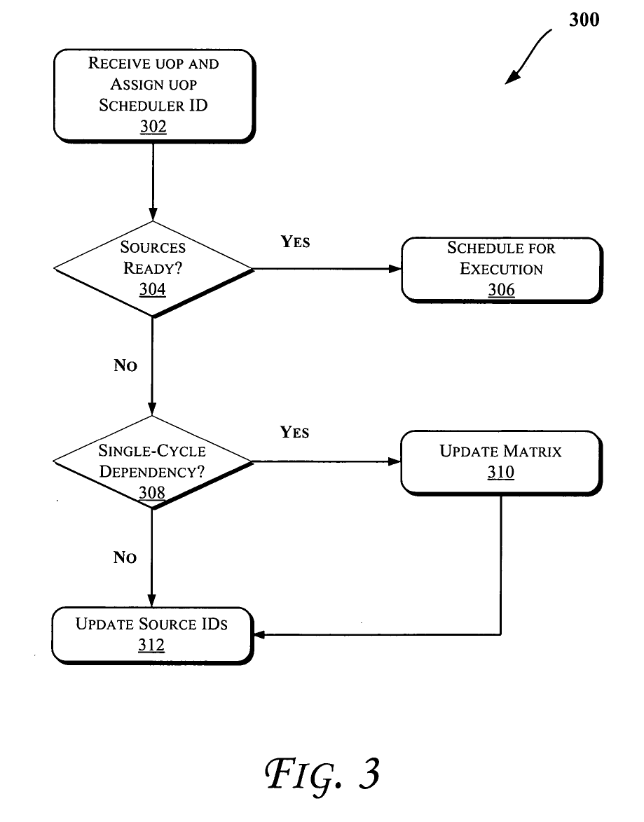

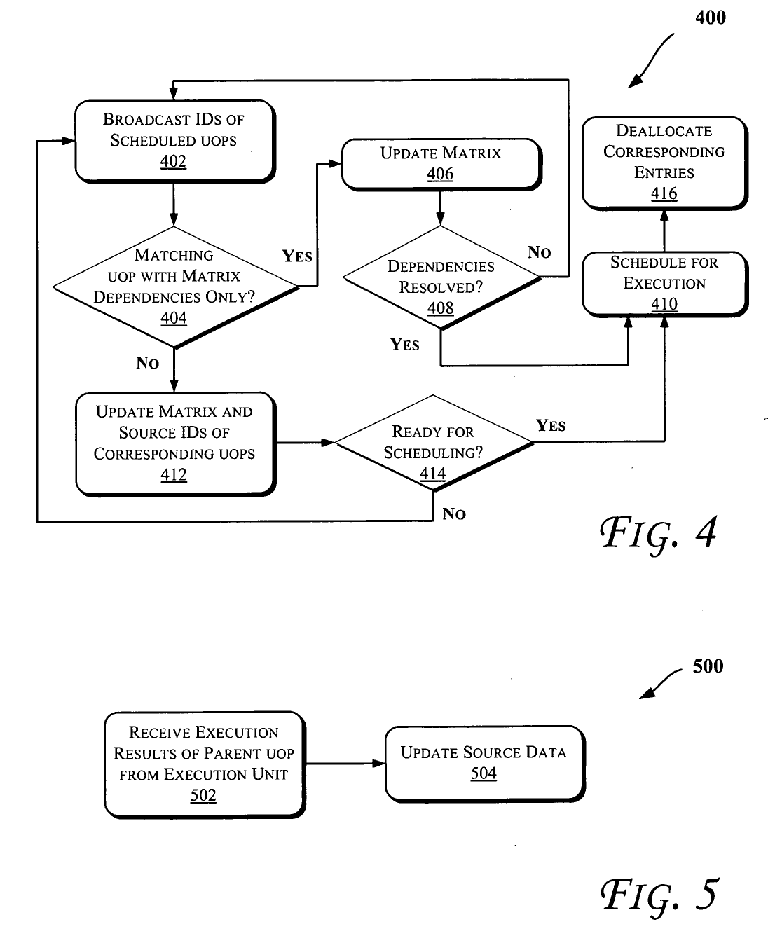

The scheduler 202 may be coupled to a uop dependency matrix 204 and a uop source identifiers (IDs) and data buffer 206. In an embodiment, one or more of the uop dependency matrix 204 or the uop source IDs and data buffer 206 may be stored in the memory 112 of FIG. 1. The uop dependency matrix 204 may store information 208 (e.g., in a matrix format) that indicates which one of the uops waiting to be scheduled in the schedule unit 107 have single cycle dependencies. For example, the uop dependency rows and columns may be indexed by the uop scheduler IDs 210. In an embodiment, entries of the matrix 204 may be set when a dependency exists and cleared otherwise. Of course, the reverse is also possible depending on the implementation. Furthermore, the uop scheduler IDs 210 may be assigned by the scheduler 202 (or some other prior unit in the pipeline such as a decoder or an allocator, which may be implemented in the decode unit 104 in an embodiment), e.g., when a new uop is allocated into the schedule unit 107, as will be further discussed herein with reference to FIGS. 3 and 4, for example. In an embodiment, the matrix 204 may have an n×n size, where n is the depth of the schedule unit 107.

The uop source identifiers (IDs) and data buffer 206 may include entries that store a uop scheduler ID (210) along with one or more source IDs (e.g., 212 an 214) and source data (e.g., 216 and 218). The uop source identifiers (IDs) and data buffer 206 may also store ready status bits (e.g., 220 and 222) that correspond to each source of the uop scheduler ID (210). For example, the ready status bits 224 and 226 may respectively correspond to the source IDs 212 and 214 (and/or source data 216 and 218).

The operation of various components of FIG. 2 will now be discussed with reference to FIGS. 3-5. FIG. 3 illustrates a flow diagram of an embodiment of a method 300 to allocate a new uop in a schedule unit. In an embodiment, the method 300 allocates uops in the schedule unit 107 of FIGS. 1 and/or 2. Hence, the operations of the method 300 may be performed by one or more components of a processor core, such as the components discussed with reference to FIGS. 1 and/or 2.

Referring to FIGS. 2 and 3, the schedule unit 107 may receive a uop from the decode unit 104 at an operation 302. The received uop (302) may be allocated into the schedule unit 107 after it is decoded by the decode unit 104. The operation 302 may also assign a uop scheduler ID (210) to the received uop, e.g., for internal processing of the uops within the schedule unit 107. At an operation 304, the scheduler 202 may determine if the sources of the received uop are ready (for example, by accessing the status bits 224 and/or 226). If the uop sources are ready, the uop is scheduled for execution (306) and the scheduler 202 sends the uop to the execution unit 108 for execution. If the sources are not ready, the scheduler 202 may determine (308) whether the received uop (302) has one or more single-cycle dependencies (e.g., by accessing the corresponding dependency ID 106C). If the received uop has at least one single-cycle dependency (308), the corresponding entries in the uop dependency matrix 204 are updated (310). For example, a uopA may be dependent on both uopB and uopC (see, e.g., the information 208 of FIG. 2). Similarly, uopB may have one dependency (on uopC) and uopC may have no dependencies.

Furthermore, as shown in FIG. 2, the decode unit 104 may include a renamer unit 228 that is coupled to the RAT 105, for example, to map logical (or architectural) registers (such as those identified by operands of software instructions) to corresponding physical registers. This may allow for dynamic expansion of general use registers to use available physical registers. In one embodiment, the renamer unit 228 may initially provide the values for the source IDs (212 and 214) and dependency ID (106C) to the scheduler 202 when the uop is allocated into the schedule unit 107 (302). Moreover, after the operations 308 and 310, the scheduler 202 may store the initial values received from the renamer unit 228 in the uop source IDs and data buffer 206 (312) and update the uop dependency matrix 204 (310). Hence, the source IDs stored in the uop source IDs and data buffer 206 (e.g., 212 and/or 214) may be updated (312) by the scheduler 202. Additionally, the operations of the method 300 may be performed in various orders. For example, the operation 312 may be performed prior to the operations 308 and/or 310.

FIG. 4 illustrates a flow diagram of an embodiment of a method 400 to schedule uops with source dependencies for execution. In an embodiment, the method 400 schedules uops awaiting scheduling in the schedule unit 107 of FIGS. 1 and/or 2. In one embodiment, the operations of the method 400 may be performed by one or more components of a processor core, such as the components discussed with reference to FIGS. 1 and 2.

Referring to FIGS. 2 and 4, the scheduler 202 broadcasts (402) the uop scheduler IDs (210) of scheduled uops to one or more uops awaiting scheduling in the schedule unit 107. At an operation 404, the scheduler 202 determines whether any of the matching uops awaiting scheduling in the schedule unit 107 have only dependencies expressed in the uop dependency matrix 204 (e.g., where the ready status bits 224 and/or 226 indicate that no dependencies exist in the uop source IDs and data buffer 206). If a matching uop has dependencies expressed only in the uop dependency matrix 204 (404), the scheduler 202 updates one or more entries matching the broadcasted uop scheduler identifier (402) in the uop dependency matrix 204 (406). In an embodiment, the operation 406 may be performed by clearing the dependencies of all rows in a column of the matrix 204 that corresponds to the broadcasted uop scheduler identifier (402) (e.g., effectively resolving the dependency).

At an operation 408, the scheduler 202 determines whether all dependencies of the matching uop (404) are resolved. If all dependencies of the matching uop are resolved in the uop dependency matrix 204 (for the uop determined to only have dependencies in the uop dependency matrix 204 at the operation 404), the matching uop is scheduled for execution (410); otherwise, the method 400 resumes at the operation 402.

At the operation 404, for uops that have dependencies other than matrix dependencies only (e.g., those that have one or more source dependencies expressed in the uop source IDs and data buffer 206, alone or in addition to dependencies expressed in the uop dependency matrix 204), the method 400 continues with an operation 412 which updates one or more entries matching the uop scheduler identifier in one or more entries of the uop dependency matrix 204 and/or the uop source identifiers and data buffer 206.

With respect to the uop dependency matrix 204 at the operation 412, uops may set their dependency on the columns of the matrix (204) that correspond to the scheduler entries that hold the parent uops, e.g., on which the uops setting their dependencies are dependent, as discussed with reference to FIG. 2. When a uop schedules, the scheduler 202 may clear all dependencies that are set on the scheduled uop column, e.g., to make that source ready for all dependent uops. For instance, if uopC schedules, the corresponding uopC column is cleared which removes uopA and uopB's dependencies on uopC.

With respect to the uop source IDs and data buffer 206 at the operation 412, the broadcasted uop scheduler ID (210) may be matched against entries within the uop source IDs and data buffer 206. The corresponding ready status bits (e.g., 224 and/or 226) may be cleared if the source IDs (e.g., 212 and/or 214, respectively) match the broadcasted uop scheduler ID of the operation 402.

After the operation 412, the scheduler 202 may determine whether the matching uop (e.g., having a source ID that matches the broadcasted ID of the operation 402 or dependency as expressed in the uop dependency matrix 204) is ready for scheduling (414). For example, the operation 414 may determine whether the uop sources (e.g., as expressed by the ready status bits 224 and 226) are ready for scheduling and/or any dependencies expressed in the uop dependency matrix 204 remain unresolved (such as discussed with reference to the operation 408). If the matching uop is ready for scheduling (414), the scheduler 202 schedules the uop for execution (410). Once a uop is dispatched for execution (410) (e.g., passed any cancellation windows), the corresponding entries in the uop dependency matrix 204 and the uop source IDs and data buffer 206 are deallocated (416).

In one embodiment, regardless of the nature of the matching uop dependencies (e.g., as expressed in the uop dependency matrix 204 or the uop source IDs and data buffer 206) the source IDs (e.g., 212 and 214) are matched on the broadcasted IDs (402). Hence, the operation 412 may be performed even if the operation 404 determines that a matching uop has matrix dependencies only. Also, performance of the operation 412 may be used for source data capture (e.g., within the source data fields 216 and 218), for controlling source bypass (e.g., the flow including operations 402, 404, 406 and 410), uop cancellation, and/or rescheduling the uop (e.g., where a uop is rescheduled for execution in a later cycle than when the uop's sources are ready and all its dependencies are resolved).

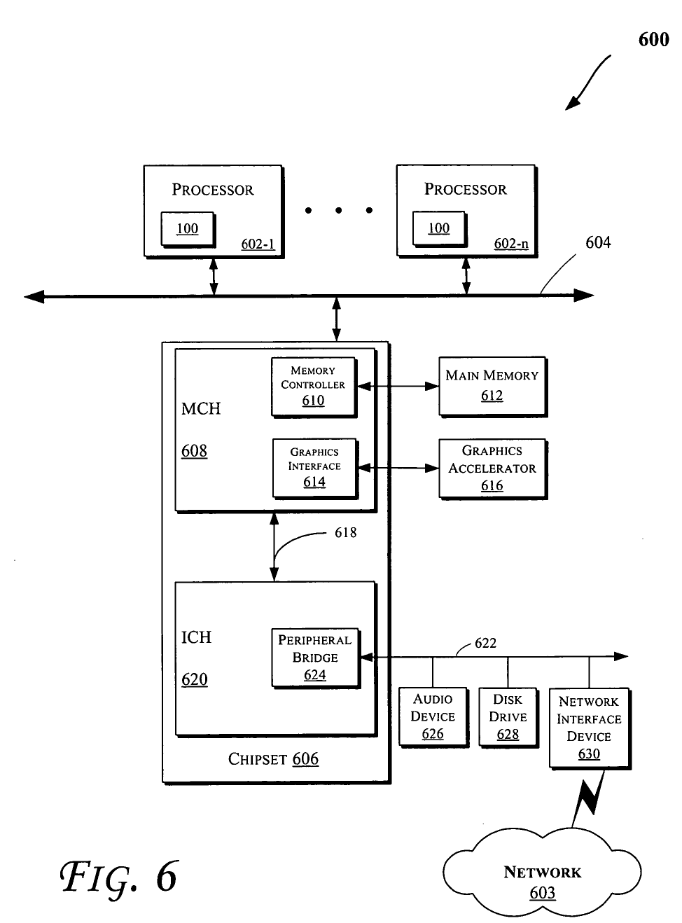

FIG. 5 illustrates a flow diagram of an embodiment of a method 500 to update uop source data. In an embodiment, the operations of the method 500 may be performed by various components of a processor core, such as those discussed with reference to FIGS. 1 and 2. Referring to FIGS. 2 and 5, the scheduler 202 receives (502) execution results of a uop executed by the execution unit 108. The scheduler 202 updates the corresponding source data information (504) in the uop source IDs and data buffer 206, e.g., by storing the execution results of the operation 502 in the corresponding source data field 216 and/or 218.

FIG. 6 illustrates a block diagram of a computing system 600 in accordance with an embodiment of the invention. The computing system 600 may include one or more central processing unit(s) (CPUs) 602 or processors coupled to an interconnection network (or bus) 604. The processors (602) may be any suitable processor such as a general purpose processor, a network processor (that processes data communicated over a computer network 603), or the like (including a reduced instruction set computer (RISC) processor or a complex instruction set computer (CISC)). Moreover, the processors (602) may have a single or multiple core design. The processors (602) with a multiple core design may integrate different types of processor cores on the same integrated circuit (IC) die. Also, the processors (602) with a multiple core design may be implemented as symmetrical or asymmetrical multiprocessors. In an embodiment, one or more of the processors 602 may include one or more of the processor core 100 of FIG. 1. Also, the operations discussed with reference to FIGS. 1-5 may be performed by one or more components of the system 600.

A chipset 606 may also be coupled to the interconnection network 604. The chipset 606 may include a memory control hub (MCH) 608. The MCH 608 may include a memory controller 610 that is coupled to a memory 612. The memory 612 may store data and sequences of instructions that are executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 604, such as multiple CPUs and/or multiple system memories.

The MCH 608 may also include a graphics interface 614 coupled to a graphics accelerator 616. In one embodiment of the invention, the graphics interface 614 may be coupled to the graphics accelerator 616 via an accelerated graphics port (AGP). In an embodiment of the invention, a display (such as a flat panel display) may be coupled to the graphics interface 614 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 618 may couple the MCH 608 to an input/output control hub (ICH) 620. The ICH 620 may provide an interface to I/O devices coupled to the computing system 600. The ICH 620 may be coupled to a bus 622 through a peripheral bridge (or controller) 624, such as a peripheral component interconnect (PCI) bridge, a universal serial bus (USB) controller, or the like. The bridge 624 may provide a data path between the CPU 602 and peripheral devices. Other types of topologies may be utilized. Also, multiple buses may be coupled to the ICH 620, e.g., through multiple bridges or controllers. Moreover, other peripherals coupled to the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 622 may be coupled to an audio device 626, one or more disk drive(s) 628, and a network interface device 630 (which is coupled to the computer network 603). Other devices may be coupled to the bus 622. Also, various components (such as the network interface device 630) may be coupled to the MCH 608 in some embodiments of the invention. In addition, the processor 602 and the MCH 608 may be combined to form a single chip. Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media suitable for storing electronic instructions and/or data.

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-5 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to couple with memories 710 and 712. The memories 710 and/or 712 may store various data such as those discussed with reference to the memories 112 of FIG. 1 and/or 612 of FIG. 6.

The processors 702 and 704 may be any suitable processor such as those discussed with reference to the processors 602 of FIG. 6. The processors 702 and 704 may exchange data via a point-to-point (PtP) interface 714 using PtP interface circuits 716 and 718, respectively. The processors 702 and 704 may each exchange data with a chipset 720 via individual PtP interfaces 722 and 724 using point to point interface circuits 726, 728, 730, and 732. The chipset 720 may also exchange data with a high-performance graphics circuit 734 via a high-performance graphics interface 736, using a PtP interface circuit 737.

At least one embodiment of the invention may be provided within the processors 702 and 704. For example, the processor core 100 of FIG. 1 may be located within the processors 702 and 704. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7.

The chipset 720 may be coupled to a bus 740 using a PtP interface circuit 741. The bus 740 may have one or more devices coupled to it, such as a bus bridge 742 and I/O devices 743. Via a bus 744, the bus bridge 743 may be coupled to other devices such as a keyboard/mouse 745, communication devices 746 (such as modems, network interface devices, or the like that may be coupled to the computer network 603), audio I/O device, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIGS. 1, 6, and 7.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
broadcasting a uop scheduler identifier of a scheduled uop to one or more uops awaiting scheduling; and
updating one or more entries matching the uop scheduler identifier in one or more of a uop dependency matrix or a uop source identifiers and data buffer.

2. The method of claim 1, wherein updating the one or more entries comprises marking one or more of the matched entries in the uop source identifiers and data buffer as ready.

3. The method of claim 2, wherein the marking is performed by clearing a corresponding bit in the uop source identifiers and data buffer.

4. The method of claim 1, wherein updating the one or more entries comprises marking one or more of the matched entries in the uop dependency matrix as independent.

5. The method of claim 4, wherein the marking is performed by clearing a corresponding bit in the uop dependency matrix.

6. The method of claim 1, wherein each entry in the uop dependency matrix indicates whether one or more sources of a first uop are dependent on an execution result of a single-cycle second uop.

7. The method of claim 1, further comprising scheduling a uop for execution once all sources of the uop are ready for scheduling.

8. The method of claim 1, further comprising, for a uop with one or more dependencies identified in the uop dependency matrix and all ready bits set in the uop source identifiers and data buffer, scheduling the uop for execution once the one or more dependencies in the uop dependency matrix clear.

9. The method of claim 1, further comprising receiving execution results of the scheduled uop and updating corresponding source data fields in the uop source identifiers and data buffer.

10. The method of claim 1, further comprising:
receiving a uop for scheduling; and
updating a corresponding entry of the uop dependency matrix to indicate a single-cycle dependency status of the received uop.

11. The method of claim 1, further comprising deallocating corresponding entries in the uop dependency matrix and the uop source identifiers and data buffer once a uop is dispatched for execution.

12. The method of claim 1, further comprising utilizing a reservation based scheduler to perform the scheduling.

13. An apparatus comprising:
a scheduler to:
broadcast a uop scheduler identifier of a scheduled uop to one or more uops awaiting scheduling; and
update one or more entries matching the uop scheduler identifier in one or more of a uop dependency matrix or a uop source identifiers and data buffer.

14. The apparatus of claim 13, further comprising a renamer unit to provide to the scheduler one or more of a source identifier, a ready status bit, or source data corresponding to a uop.

15. The apparatus of claim 13, further comprising a register alias table to store a single-cycle dependency identifier for each register.

16. The apparatus of claim 13, wherein a schedule unit comprises the scheduler, the uop dependency matrix, and the uop source identifiers and data buffer.

17. The apparatus of claim 16, wherein the schedule unit is a reservation based scheduler.

18. The apparatus of claim 16, wherein the schedule unit is an out-of-order schedule unit.

19. The apparatus of claim 13, further comprising a processor core that comprises the scheduler.

20. The apparatus of claim 19, further comprising a processor that comprises a plurality of the processor cores.

21. The apparatus of claim 13, further comprising an execution unit to execute the scheduled uop.

22. A processor comprising:
means for decoding instructions into a plurality of uops;
means for broadcasting a uop scheduler identifier of a scheduled uop to one or more uops awaiting scheduling;
means for storing one or more entries corresponding to the one or more uops awaiting scheduling; and
means for updating one or more entries matching the uop scheduler identifier.

23. The processor claim 22, further comprising means for executing the scheduled uop.

24. The processor of claim 22, further comprising means for scheduling a uop for execution once all sources of the uop are ready for scheduling.

25. A system comprising:
a memory to store one or more entries indicative of one or more of a single-cycle dependency status or source data status of a plurality of uops awaiting scheduling; and
a scheduler to determine whether one or more of the plurality of uops are eligible for execution based on the one or more entries.

26. The system of claim 25, further comprising an audio device.

27. The system of claim 25, wherein the memory is one or more of a RAM, DRAM, or SDRAM.

28. The system of claim 25, further comprising a processor core that comprises the scheduler.

29. The system of claim 28, further comprising a processor that comprises a plurality of the processor cores.

30. The system of claim 25, wherein the scheduler updates the one or more entries based on an identifier of a scheduled uop.
